(19) United States
(12) Patent Application Publication
(10) Pub. No.: US 2017/0326913 A1
(43) Pub. Date: Nov. 16, 2017

(54) Rolling Assembly

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Jose MERINO LOPEZ, Clermont-Ferrand Cedex 09 (FR); Michel AHOUANTO, Clermont-Ferrand Cedex 09 (FR)

(73) Assignees: COMPAGNIE GENERALE DES ETABLISSEMENTS MICHELIN, Clermont-Ferrand (FR); MICHELIN RECHERCE ET TECHNIQUE S.A., Granges-Paccot (CH)

(21) Appl. No.: 15/526,878

(22) PCT Filed: Sep. 29, 2015
(86) PCT No.: PCT/EP2015/072345

§ 371 Date: May 15, 2017

(30) Foreign Application Priority Data
Nov. 18, 2014 (FR) 1461119

(51) Int. Cl. B60B 25/04; B60B 25/22; B29C 73/16; B29D 30/06; B29C 73/22; B60C 19/12; B60B 25/08

(52) U.S. Cl. CPC B60B 25/045; B60C 19/122; B60B 25/22; B60B 25/08; B29C 73/163; B29D 30/0685; B29C 73/22; B29D 2030/0686

(57) ABSTRACT

Adapter for a rolling assembly comprising a tire, and a rim having two rim seats and two rim flanges. The adapter has an axially inner end mounted on the rim seat and comprises an inner reinforcing element, an axially outer end that comprises an outer reinforcing element, a body that connects the two ends to form a single piece. A substantially cylindrical adapter seat is configured to receive a bead, and is situated at the axially outer end of the body. An adapter bearing face is substantially contained in a plane perpendicular to the rotation axis, and situated on the axially inner face of the axially outer end. The reinforcing element of the axially outer end is entirely situated axially outside the bearing face. The body comprises, opposite the adapter seat, an annular seat reinforcer. The inner wall of the tire is covered by a layer of a self-sealing composition.

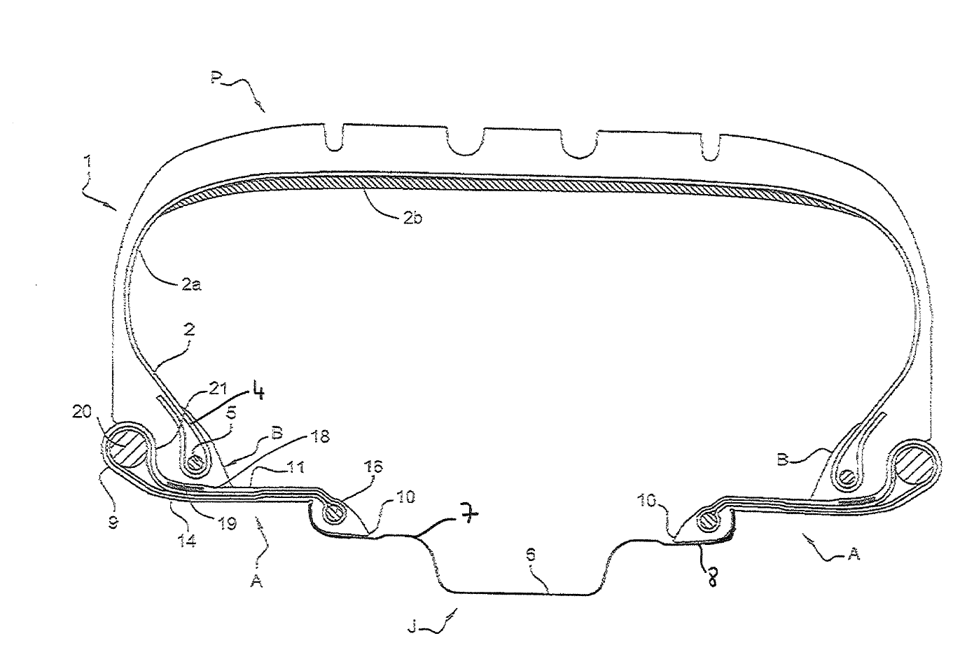

The invention relates to a rolling assembly formed mainly of a tire and a rim and that is intended for passenger vehicles and vans.

A reminder of the definitions used in the present invention is given below:
“axial direction” is a direction parallel to the rotation axis of the tire,
“radial direction” is a direction that intersects the rotation axis of the tire and is perpendicular thereto,
“circumferential direction” is a direction perpendicular to a radius and contained in a plane perpendicular to the rotation axis of the tire,
“radial section” is a section in a plane which contains the rotation axis of the tire,
“equatorial plane” is the plane perpendicular to the rotation axis and passing through the middle of the tread.

It is already known from the application WO00/78565 to insert an elastic adapter between the rim and the beads of a tire. This adapter is elastically deformable in the radial and axial directions. Such an adapter makes it possible to separate that part of the rolling assembly that can be considered to actually act as a tire from that part of the rolling assembly that can be considered to act as a rim.

However, although such an assembly also makes it possible to ensure the functions of a conventional tire, notably a drift thrust response of the tire following the application of a drift angle to the tire, thereby giving the assembly sufficient flexibility to avoid any surface deterioration or depth deterioration thereto, it does not however perfectly reduce the wear of the tire and of the adapter during rare cases of flattening of said tire, for example following an impact with a kerb or in a pothole or else following puncturing by objects of small or large diameters (greater than or equal to 7 mm).

Indeed, in these rare cases, the tire running flat will be in contact with the adapter in an unequal manner due to the different speeds between the speed of the tire and that of the adapter. This difference in speed results in a slipping phenomenon between the tire and the adapter. This slipping will cause the premature wear of the tire and of the adapter.

No suggestion is given in this document regarding structural adaptations that would lead to this wear being reduced.

Also, there remains the need for a new device comprising an adapter that ensures a better protection of the tire when running flat, following a violent impact or a puncture.

The subject of the invention is therefore a rolling mounted assembly having a rotation axis and comprising:
a tire having two beads and an inner wall,
at least one adapter,
a rim,
said adapter providing the connection between one of the beads and the rim,
   said rim having two rim seats and two rim flanges,
   said adapter having:
an axially inner end that is intended to be mounted on the rim seat and comprises an inner reinforcing element,
an axially outer end that comprises an outer reinforcing element,
a body that connects said outer end to said inner end so as to form a single piece and comprises at least one main reinforcement that provides the connection between said outer reinforcer and said inner reinforcer,
a substantially cylindrical adapter seat intended to receive one of said beads, said seat being situated at the axially outer end of said body,
an adapter bearing face substantially contained in a plane perpendicular to the rotation axis, said bearing face being situated on the axially inner face of the axially outer end.

The reinforcing element of the axially outer end is entirely situated axially outside the bearing face, and the body comprises, opposite the adapter seat, an annular seat reinforcer. The adapter is characterized in that the inner wall of the tire is covered by a layer of a self-sealing composition.

The self-sealing composition may have a Shore 00 hardness of less than or equal to 10.

The Shore hardness makes it possible to measure the resistance to the penetration of an indenter applied to a test specimen of vulcanized elastomer or directly to a tire. This measurement parameter provides an indication of the stiffness of the elastomer. The measurement is carried out by applying a force resulting from the compression of a calibrated spring for a duration of three seconds, at a temperature of 23° C.±2. The higher the numerical value of the Shore hardness, the lower the penetration. The Shore 00 hardness makes it possible to accurately measure very low stiffness values by extension of the measurement scale for low stiffnesses.

The self-sealing composition may be selected from a composition based on a thermoplastic stirene (TPS) elastomer, or from a composition comprising at least one unsaturated diene elastomer, or from terpene and polybutene resins as main component, or from silicone-based, urethane-based, stirene-based or else ethylene-based compounds, or from a composition based on a butyl elastomer.

Preferably, the composition based on a thermoplastic stirene (TPS) elastomer comprises more than 200 phr of an extender oil for extending said elastomer.

Preferably, the composition comprising at least one unsaturated diene elastomer comprises between 30 and 90 phr of a hydrocarbon resin, a liquid plasticizer, the glass transition temperature (Tg) of which is below −20° C., at a weight content of between 0 and 60 phr and from 0 to 120 phr of a filler.

Preferably, the composition based on a butyl elastomer comprises a non-halogenated butyl elastomer.

Preferably, the composition based on a butyl elastomer comprises between 5 and 40 phr of an extender oil selected from polyisobutylene, between 5 and 55 phr of a tackifying resin, and a non-reinforcing filler. Preferably, the polyisobutylene has a molecular weight of less than or equal to 10 000, and preferentially less than or equal to 5000, and the non-reinforcing filler may be selected from chalk or kaolin.

This self-sealing composition may also be selected from terpene and polybutene resins as main component, or else from silicone-based, urethane-based, stirene-based or else ethylene-based compounds.

The self-sealing composition has a lubricating role during contact between the tire and the adapter, thus protecting the surfaces abnormally bought into contact, and consequently protecting them from premature wear.

The mounted assembly according to the invention has the advantage of having a simple design and being easy to mount. The mounted assembly according to the invention furthermore makes it possible to protect the tire against impacts and punctures of the tread.

Finally, the adapter according to the invention has the advantage of significantly reducing the level of mechanical forces towards the chassis in the event of an impact, and thus of making it possible to make the body shell of the vehicle lighter.

Preferably, the annular seat reinforcer has a compression modulus greater than or equal to 1 GPa, and preferably greater than 4 GPa, and more preferably greater than 10 GPa. The annular reinforcer may be made up of a core surrounded by an elastomer, or of a succession of layers of elastomer compounds and metal and/or textile reinforcers positioned in any possible combination. The core may comprise at least one element chosen from a metal, a composite material, a thermoplastic, and a mixture thereof. The composite material may be made from glass fibres embedded in a resin matrix.

The list of elastomers that can be used includes, firstly, rubbers that are crosslinkable by chemical vulcanization reactions by sulphur bridges, by carbon-carbon bonds created by the action of peroxides or of ionizing radiation, by other specific atom chains of the elastomer molecule, secondly, thermoplastic elastomers (TPEs) in which the elastically deformable part forms a network between rather non-deformable “hard” regions, the cohesion of which is the product of physical connections (crystallites or amorphous regions above their glass transition temperature), and next non-thermoplastic elastomers and finally thermosetting resins.

The annular seat reinforcer may be made up of at least two layers of different constituents positioned successively and in alternation. Positioned in alternation means successive disposition of a first layer and then a second layer, several times.

The annular seat reinforcer may have an overall axial length greater than or equal to 30% of the width of the bead of the tire, and less than 150% of this same width, and more preferably between 40 and 110% of the width of the bead of the tire.

The annular seat reinforcer may have a mean radial thickness greater than or equal to 0.3 mm and less than or equal to 20 mm depending on the size and the use of the tire. Thus, for a passenger vehicle tire, the thickness is preferably between 0.5 and 10 mm.

The annular seat reinforcer preferably comprises at least one element chosen from a metal, a composite material, a thermoplastic, and a mixture thereof. This core or this multilayer is preferably contained between two layers of a matrix comprising the choice of an elastomer as cited above, a resin or a mixture thereof.

The annular seat reinforcer preferably consists of a stack of different layers of elastomer compounds with identical or different chemical natures.

When it is in the form of a stack of layers, the reinforcer preferably has an axial length greater than 5 mm and less than 25 mm and a radial thickness greater than or equal to 0.1 mm and less than or equal to 4 mm.

Each single element of which the stack of the reinforcer is made may have an axial width greater than 1 mm and less than 25 mm and an identical or different radial thickness greater than or equal to 0.1 mm and less than or equal to 2 mm.

The annular seat reinforcer may also be in the form of a stack of single threads between a layer of a matrix comprising the choice of an elastomer, a thermoplastic compound, a resin, or mixtures thereof. The single threads may be threads that are conventionally used, such as textile threads (polyester, nylon, PET, aramid, rayon, natural fibres (cotton, flax, hemp)), metal threads, composite threads (carbon, glass-reinforced resin), or mixtures of these constituents.

The annular seat reinforcer may also be in the form of one or more plies, the reinforcers of which are positioned at an angle of between 0 and 90° with respect to the circumferential direction of the tire.

Preferably, the annular reinforcer may be positioned radially on the outside or radially on the inside of the body of the adapter, on either side of said body, or else between the plies of reinforcing elements of the body of the adapter.

The outer reinforcing element may consist of metal (steel), nylon, PET or aramid. It may comprise a matrix of resin and/or reinforcing fibres, such as rayon, aramid, PET, nylon, glass fibre, carbon fibre, basalt fibre, poly(ethylene 2,6-naphthalate) (PEN), polyvinyl alcohol (PVA).

The main reinforcement of said body may have a modulus greater than or equal to 4 GPa; it may consist of metal (steel), of textile cord (rayon, aramid, PET, nylon, glass fibre, carbon fibre, basalt fibre, poly(ethylene 2,6-naphthalate) (PEN), or polyvinyl alcohol (PVA)).

Preferably, the adapter may be positioned on just one side of the rim, and preferably on the outer side of the vehicle. In this case, the rim has an asymmetrical geometric shape so as to adapt to the presence of the adapter present on just one side.

The adapter may also be present on each side of the rim.

When the mounted assembly comprises two adapters, the latter may be symmetrical or non-symmetrical. The concept of symmetry or asymmetry of the adapter is defined by the axial length of the body of the adapter. Two adapters are asymmetrical when the body of one of them has an axial length greater than that of the other.

Preferably, TPS is the predominant elastomer of the self-sealing layer.

Preferably, the TPS elastomer is selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS), stirene/ethylene/ethylene/propylene/stirene (SEEPS) block copolymers and mixtures of these copolymers.

Preferably, the TPS elastomer is selected from the group consisting of SEBS copolymers, SEPS copolymers and mixtures of these copolymers.

Preferably, the unsaturated diene elastomer is selected from the group consisting of polybutadienes, natural rubber, synthetic polyisoprenes, butadiene copolymers, isoprene copolymers and mixtures of such elastomers.

Preferably, the unsaturated diene elastomer is an isoprene elastomer, preferably selected from the group consisting of natural rubber, synthetic polyisoprenes and mixtures of such elastomers the unsaturated diene elastomer is an isoprene elastomer, preferably selected from the group consisting of natural rubber, synthetic polyisoprenes and mixtures of such elastomers.

Preferably, the unsaturated diene elastomer is a blend of at least two solid elastomers, a polybutadiene or butadiene copolymer elastomer, referred to as “elastomer A”, and a natural rubber or synthetic polyisoprene elastomer, referred to as “elastomer B”, the elastomer A:elastomer B weight ratio being within a range from 10:90 to 90:10.

Preferably, the elastomer A:elastomer B weight ratio is within a range from 20:80 to 80:20, preferably from 30:70 to 70:30.

Preferably, the rim is made from a material selected from steel, alloys of aluminium and/or of magnesium, composite materials based on carbon fibres, glass fibres, aramid fibres, plant fibres, said fibres being comprised in a matrix based on thermosetting compounds or on thermoplastic compounds, or from a complex compound comprising an elastomer and a complex based on resin and fibres selected from carbon fibres, glass fibres, aramid fibres, plant fibres or from any combination of materials.

Preferably, the fibre-based composite materials contain fibres of a length greater than or equal to 5 mm.

The matrix based on thermosetting compounds may be selected from epoxy resins, vinyl ester, unsaturated polyesters, cyanate ester, bismaleimide, acrylic resins, phenolic resins, polyurethanes and combinations thereof.

Preferably, the matrix based on thermoplastic compounds is selected from polypropylene (PP), polyethylene (PE), polyamides (PAs), semiaromatic polyamides, polyester (PET), polybutylene terephthalate (PBT), polyetheretherketone (PEEK), polyetherketoneketone (PEKK), polyethersulphone (PSU), polyetherimide (PEI), polyimide (PI), polyamideimide (PAI), polyphenylene sulphide (PPS), polyoxymethylene (POM), polyphenylene oxide (PPO).

In the following text, unless expressly indicated otherwise, all the percentages (%) shown are % by weight.

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The abbreviation “phr” means parts by weight per hundred parts of elastomer in the solid state (of the total of the solid elastomers, if several solid elastomers are present).

The expression composition “based on” should be understood generally as meaning a composition comprising the mixture and/or the reaction product of the various components thereof, it being possible for some of these components to be capable of reacting (or even intended to react) with one another, at least in part, during the various phases of manufacture of the composition, for example during the possible final crosslinking or vulcanization (curing) thereof.

### I-1. Layer of Self-Sealing Product Based on a Thermoplastic Stirene Elastomer

According to one embodiment, the self-sealing layer 55 comprises a thermoplastic stirene (TPS) elastomer and more than 200 phr of an extender oil for extending the elastomer. Thermoplastic stirene elastomers are thermoplastic elastomers in the form of stirene-based block copolymers.

With a structure intermediate between thermoplastic polymers and elastomers, they are made up, in a known way, from polystirene hard sequences linked by elastomer soft sequences, for example polybutadiene, polyisoprene or poly(ethylene/butylene). They are often triblock elastomers with two hard segments connected by a soft segment. The hard and soft segments can be positioned linearly, or in a star or branched configuration.

The TPS elastomer is selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS), stirene/ethylene/ethylene/propylene/stirene (SEEPS) block copolymers and mixtures of these copolymers.

More preferably, the elastomer is selected from the group consisting of SEBS copolymers, SEPS copolymers and mixtures of these copolymers.

The TPS elastomer may constitute the whole of the elastomer matrix or the majority by weight (preferably with a content of more than 50%, more preferentially with a content of more than 70%) of the latter when it comprises one or more other thermoplastic or non-thermoplastic elastomer(s), for example of diene type.

Examples of such self-sealing layers and the properties thereof are disclosed in documents FR 2 910 382, FR 2 910 478 and FR 2 925 388.

Such a self-sealing layer may be preformed by extrusion of a flat profiled element to the dimensions suitable for its application onto a building drum. One exemplary embodiment is presented in document FR 2 925 388.

### I-2. Layer of Self-Sealing Product Based on Diene Elastomer

According to another exemplary embodiment, the self-sealing layer 55 consists of an elastomer composition comprising at least, as predominant elastomer (preferably with a content of more than 50 phr), an unsaturated diene elastomer, between 30 and 90 phr of a hydrocarbon resin and a liquid plasticizer, having a glass transition temperature or Tg below −20° C., with a content of between 0 and 60 phr (phr denoting parts by weight per hundred parts of solid elastomer). It has another essential feature of containing no filler or of containing less than 120 phr thereof.
Diene elastomer

It is recalled that a “diene” elastomer or rubber should be understood, in a known way, as meaning an elastomer resulting at least in part (i.e., a homopolymer or a copolymer) from diene monomers (monomers bearing two conjugated or non-conjugated carbon-carbon double bonds).

These diene elastomers can be classified into two categories, saturated or unsaturated. In the present application, the term “unsaturated” (or “essentially unsaturated”) diene elastomer is understood to mean a diene elastomer resulting at least in part from conjugated diene monomers and having a content of units obtained from conjugated dienes that is greater than 30% (mol %). Thus, excluded from this definition are diene elastomers such as butyl rubbers or copolymers of dienes and alpha-olefins of EPDM type which may be described as “saturated” or “essentially saturated” diene elastomers because of their low content of units of diene origin (always less than 15 mol %).

Use is preferably made of an unsaturated diene elastomer with a content (in mol %) of units of diene origin (conjugated dienes) of greater than 50%, such a diene elastomer being more preferably selected from the group consisting of polybutadienes (BRs), natural rubber (NR), synthetic polyisoprenes (IRs), butadiene copolymers (for example stirene-butadiene copolymers or SBR), isoprene copolymers (of course, other than butyl rubber) and mixtures of such elastomers.

Compared with diene elastomers of the liquid type, the unsaturated diene elastomer of the composition is by definition solid. Preferably, its number-average molecular weight (Mn) is between 100 000 and 5 000 000, more preferably between 200 000 and 4 000 000 g/mol. The Mn value is determined in a known manner, for example by SEC: solvent tetrahydrofuran; temperature 35° C.; concentration 1 g/l; flow rate 1 ml/min; solution filtered through a filter with a porosity of 0.45 μm before injection; Moore calibration using standards (polyisoprene standards); set of four Waters columns in series (Styragel HMW7, HMW6E, and 2 HT6E); detection by differential refractometer (Waters 2410) and its associated operating software (Waters Empower).

More preferably, the unsaturated diene elastomer of the composition of the self-sealing layer is an isoprene elastomer. “Isoprene elastomer” is understood to mean, in a known way, an isoprene homopolymer or copolymer, in other words a diene elastomer selected from the group consisting of natural rubber (NR), synthetic polyisoprenes (IRs), butadiene-isoprene copolymers (BIRs), stirene-isoprene copolymers (SIRs), stirene-butadiene-isoprene copolymers (SBIRs) and mixtures of these elastomers.

This isoprene elastomer is preferably natural rubber or a synthetic cis-1,4-polyisoprene; use is preferentially made, among these synthetic polyisoprenes, of polyisoprenes having a content (mol %) of cis-1,4-bonds of greater than 90%, more preferentially still of greater than 95%, in particular greater than 98%.

The above unsaturated diene elastomer, in particular an isoprene elastomer such as natural rubber, may constitute the whole of the elastomer matrix or the majority by weight (preferably with a content of more than 50%, more preferentially with a content of more than 70%) of the latter when it comprises one or more other diene or non-diene elastomer(s), for example of thermoplastic type. In other words, and preferably, in the composition, the content of (solid) unsaturated diene elastomer, in particular of isoprene elastomer such as natural rubber, is greater than 50 phr, more preferentially greater than 70 phr. More preferentially still, this content of unsaturated diene elastomer, in particular of isoprene elastomer such as natural rubber, is greater than 80 phr.

According to one particular embodiment, the layer of self-sealing product comprises, preferentially as predominant elastomer, a blend (or “mixture”) of at least two solid elastomers:
at least one (i.e. one or more) polybutadiene or butadiene copolymer, referred to as “elastomer A”, and
at least one (i.e. one or more) natural rubber or synthetic polyisoprene, referred to as “elastomer B”.

Mention may in particular be made, as polybutadienes, of those having a content of 1,2-units of between 4% and 80% or those having a cis-1,4-content of greater than 80%. Mention may in particular be made, as butadiene copolymers, of butadiene-stirene copolymers (SBRs), butadiene-isoprene copolymers (BIRs) or stirene-butadiene-isoprene copolymers (SBIRs). SBR copolymers having a stirene content of between 5% and 50% by weight and more particularly between 20% and 40% by weight, a content of 1,2-bonds of the butadiene part of between 4% and 65% and a content of trans-1,4-bonds of between 20% and 80%, BIR copolymers having an isoprene content of between 5% and 90% by weight and a Tg of −40° C. to −80° C., SBIR copolymers having a stirene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2-units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any SBIR copolymer having a Tg of between −20° C. and −70° C., are suitable in particular.

More preferentially still, the elastomer A is a butadiene homopolymer, in other words a polybutadiene (BR), this polybutadiene preferentially having a content (mol %) of cis-1,4-bonds of greater than 90%, more preferentially greater than 95%.

The elastomer B is natural rubber or a synthetic polyisoprene; use is preferentially made, among synthetic polyisoprenes, of cis-1,4-polyisoprenes, preferentially those having a content (mol %) of cis-1,4-bonds of greater than 90%, more preferentially still of greater than 95%, in particular of greater than 98%.

The above elastomers A and B can, for example, be block, statistical, sequential or microsequential elastomers and can be prepared in dispersion or in solution; they can be coupled and/or star-branched and/or branched or else functionalized, for example with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in U.S. Pat. No. 6,013,718), alkoxysilane groups (such as described, for example, in U.S. Pat. No. 5,977,238), carboxyl groups (such as described, for example, in U.S. Pat. No. 6,815,473 or US 2006/0089445) or else polyether groups (such as described, for example, in U.S. Pat. No. 6,503,973). Mention may also be made, as other examples of such functionalized elastomers, of elastomers (such as SBR, BR, NR or IR) of the epoxidized type.

According to one preferred embodiment, the elastomer A:elastomer B weight ratio is preferentially within a range from 20:80 to 80:20, more preferentially still within a range from 30:70 to 70:30, in particular from 40:60 to 60:40.

It is in such respective concentration ranges of the two elastomers A and B that the best compromises in terms of self-sealing properties and operating temperature have been observed, according to the various specific uses targeted, in particular during use at low temperature (in particular below 0° C.), in comparison with the use of natural rubber alone or of polybutadiene alone.

The elastomers A and B are by definition solid. In contrast to liquid, solid is understood to mean any substance not having the ability to eventually assume, at the latest after 24 hours, solely under the effect of gravity and at ambient temperature (23° C.), the shape of the container in which it is present.

In contrast to elastomers of the liquid type which can optionally be used as liquid plasticizers in the composition of the invention, the elastomers A and B and their blend are characterized by a very high viscosity: their Mooney viscosity in the raw state (i.e., non-crosslinked state) ML (1+4), measured at 100° C., is preferably greater than 20, more preferably greater than 30 and in particular between 30 and 130.

As a reminder, the Mooney plasticity or viscosity characterizes, in a known way, solid substances. Use is made of an oscillating consistometer as described in standard ASTM D1646 (1999). The Mooney plasticity measurement is carried out according to the following principle: the sample, analysed in the raw state (i.e., before curing), is moulded (shaped) in a cylindrical chamber heated to a given temperature (for example 35° C. or 100° C.). After preheating for one minute, the rotor rotates within the test specimen at 2 revolutions/minute and the working torque for maintaining this movement is measured after rotating for 4 minutes. The Mooney viscosity (ML 1+4) is expressed in “Mooney units” (MU, with 1 MU=0.83 newton-metres).

According to another possible definition, solid elastomer is also understood to mean an elastomer having a high molar mass, that is to say typically exhibiting a number-average molar mass (Mn) which is greater than 100 000 g/mol; preferably, in such a solid elastomer, at least 80%, more preferably at least 90%, of the area of the distribution of the molar masses (measured by SEC) is situated above 100 000 g/mol.

Preferably, the number-average molar mass (Mn) of each of the elastomers A and B is between 100 000 and 5 000 000 g/mol, more preferably between 150 000 and 4 000 000 g/mol; in particular, it is between 200 000 and 3 000 000 g/mol, more particularly between 200 000 and 1 500 000 g/mol. Preferably, their polydispersity index PI (Mw/Mn) is between 1.0 and 10.0, in particular between 1.0 and 3.0 as regards elastomer A and between 3.0 and 8.0 as regards elastomer B.

A person skilled in the art will know how to adjust, in the light of the present description and as a function of the specific application targeted for the composition of the invention, the average molar mass and/or the distribution of the molar masses of the elastomers A and B. According to a specific embodiment of the invention, he can, for example, opt for a broad distribution of molar masses. If he wishes to favour the fluidity of the self-sealing composition, he can instead favour the proportion of low molar masses. According to another specific embodiment, which may or may not be able to be combined with the preceding embodiment, he can also favour the proportion of intermediate molar masses for the purpose of instead optimizing the self-sealing (filling) role of the composition. According to another specific embodiment, he can instead favour the proportion of high molar masses for the purpose of increasing the mechanical strength of the self-sealing composition.

These various molar mass distributions can be obtained, for example, by mixing different starting diene elastomers (elastomers A and/or elastomers B).

According to a preferred embodiment of the self-sealing layer, the above blend of solid elastomers A and B constitutes the only solid elastomer present in the self-sealing composition of the invention, that is to say that the overall content of the two elastomers A and B is then 100 phr; in other words, the contents of elastomer A and elastomer B are consequently each within a range from 10 to 90 phr, preferably from 20 to 80 phr, more preferably from 30 to 70 phr, in particular from 40 to 60 phr.

According to another specific embodiment of the self-sealing layer, when the blend of elastomers A and B does not constitute the only solid elastomer of the composition of the invention, said blend preferably constitutes the predominant solid elastomer by weight in the composition of the invention; more preferably, the overall content of the two elastomers A and B is then greater than 50 phr, more preferably greater than 70 phr, in particular greater than 80 phr.

Thus, according to specific embodiments of the invention, the blend of elastomers A and B could be combined with other (solid) elastomers which are minority components by weight, whether they are unsaturated or saturated diene elastomers (for example butyl elastomers) or else elastomers other than diene elastomers, for example thermoplastic stirene (referred to as “TPS”) elastomers, for example selected from the group consisting of stirene/butadiene/stirene (SBS), stirene/isoprene/stirene (SIS), stirene/butadiene/isoprene/stirene (SBIS), stirene/isobutylene/stirene (SIBS), stirene/ethylene/butylene/stirene (SEBS), stirene/ethylene/propylene/stirene (SEPS) and stirene/ethylene/ethylene/propylene/stirene (SEEPS) block copolymers, and mixtures of these copolymers.

Surprisingly, the above blend of elastomers A and B, which is devoid of filler (or has a very low content of filler), has proved to be capable, after addition of a thermoplastic hydrocarbon resin within the recommended narrow range, of fulfilling the function of an effective self-sealing composition.
Hydrocarbon resin:

The second essential constituent of the self-sealing composition according to this second embodiment is a hydrocarbon resin.

The designation “resin” is reserved in the present patent application, by definition known to a person skilled in the art, for a compound which is solid at ambient temperature (23° C.), in contrast to a liquid plasticizing compound, such as an oil.

Hydrocarbon resins are polymers well known to those skilled in the art, essentially based on carbon and hydrogen, which can be used in particular as plasticizing agents or tackifiers in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, V C H, 1997, ISBN 3-527-28617-9), chapter 5 of which is devoted to their applications, in particular in the tire rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic and based or not based on petroleum (if this is the case, they are also known under the name of petroleum resins). Their glass transition temperature (Tg) is preferably above 0° C., in particular above 20° C. (most often between 30° C. and 95° C.).

In a known way, these hydrocarbon resins can also be described as thermoplastic resins in the sense that they soften when heated and can thus be moulded. They can also be defined by a softening point or temperature, at which temperature the product, for example in the powder form, sticks together; this datum tends to replace the melting point, which is rather poorly defined, for resins in general. The softening point of a hydrocarbon resin is generally approximately 50° C. to 60° C. higher than its Tg value.

In the composition of the self-sealing layer, the softening point of the resin is preferably above 40° C. (in particular between 40° C. and 140° C.), more preferably above 50° C. (in particular between 50° C. and 135° C.).

Said resin is used at a content by weight of between 30 and 90 phr. Below 30 phr, the puncture-resistance performance has proved to be inadequate due to an excessively high stiffness of the composition, whereas, above 90 phr, exposure to an inadequate mechanical strength of the material exists with in addition a risk of degraded performance at high temperature (typically above 60° C.). For these reasons, the content of resin is preferably between 40 and 80 phr, more preferably still at least equal to 45 phr, in particular within a range from 45 to 75 phr.

According to a preferred embodiment of the self-sealing layer, the hydrocarbon resin has at least (any) one, more preferentially all, of the following features:
a Tg above 25° C.;
a softening point above 50° C. (in particular between 50° C. and 135° C.);
a number-average molecular weight (Mn) of between 400 and 2000 g/mol;
a polydispersity index (PI) of less than 3 (reminder: PI=Mw/Mn with Mw being the weight-average molecular weight).

More preferably, this hydrocarbon resin exhibits at least (any) one, more preferably all, of the following features:
a Tg of between 25° C. and 100° C. (in particular between 30° C. and 90° C.);
a softening point above 60° C. (in particular between 60° C. and 135° C.);
an average mass Mn of between 500 and 1500 g/mol;
a polydispersity index (PI) of less than 2.

The Tg is measured according to standard ASTM D3418 (1999). The softening point is measured according to standard ISO 4625 (“Ring and Ball” method). The macrostructure (Mw, Mn and PI) is determined by steric exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystirene standards; set of 3 Waters columns in series (Styragel HR4E, HR1 and HR0.5); detection by differential refractometer (Waters 2410) and its associated operating software (Waters Empower).

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, C₅ fraction homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, (D)CPD/C₅ fraction copolymer resins, terpene/vinylaromatic copolymer resins, C₅ fraction/vinylaromatic copolymer resins and the mixtures of these resins.

The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, the racemate of the dextrorotatory and laevorotatory enantiomers. Suitable as vinylaromatic monomers are, for example: stirene, α-methylstirene, ortho-methylstirene, meta-methylstirene, para-methylstirene, vinyltoluene, para(tert-butyl)stirene, methoxystirenes, chlorostirenes, hydroxystirenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/stirene copolymer resins, polylimonene resins, limonene/stirene copolymer resins, limonene/D(CPD) copolymer resins, C₅ fraction/stirene copolymer resins, C₅ fraction/C₉ fraction copolymer resins and the mixtures of these resins.

All the above resins are well known to those skilled in the art and are commercially available, for example sold by DRT under the name “Dercolyte” as regards polylimonene resins, sold by Neville Chemical Company under the name “Super Nevtac” or by Kolon under the name “Hikorez” as regards C₅ fraction/stirene resins or C₅ fraction/C₉ fraction resins, or else by Struktol under the name “40 MS” or “40 NS” or by Exxon Mobil under the name “Escorez” (mixtures of aromatic and/or aliphatic resins).
Filler

The self-sealing layer composition according to this second embodiment has the other essential feature of comprising from 0 to less than 120 phr of at least one (i.e. one or more) filler, including 0 to 30 phr of at least one (i.e. one or more) reinforcing filler.

Filler is understood here to mean any type of filler, whether reinforcing (typically having nanometric particles, with a weight-average size preferably of less than 500 nm, in particular between 20 and 200 nm) or nonreinforcing or inert (typically having micrometric particles, with a weight-average size preferably of greater than 1 μm, for example between 2 and 200 μm). The weight-average size is measured in a manner well known to a person skilled in the art (by way of example, according to application WO 2009/083160 paragraph I.1).

Mention will in particular be made, as examples of fillers known as reinforcing to a person skilled in the art, of carbon black or of a reinforcing inorganic filler, such as silica in the presence of a coupling agent, or a blend of these two types of filler. Indeed, in a known manner, silica is a reinforcing filler in the presence of a coupling agent that enables it to bond to the elastomer.

All carbon blacks, especially the blacks conventionally used in pneumatic tires, are for example suitable as carbon blacks. Mention will for example be made, among the latter, of carbon blacks of 300, 600, 700 or 900 (ASTM) grade (for example, N326, N330, N347, N375, N683, N772 or N990). Suitable in particular as reinforcing inorganic fillers are highly dispersible mineral fillers of the silica (SiO₂) type, in particular precipitated or fumed silicas having a BET surface area of less than 450 m²/g, preferably from 30 to 400 m²/g.

Mention will in particular be made, as examples of inert fillers or fillers other than reinforcing fillers known to a person skilled in the art, of those selected from the group consisting of ashes (i.e., combustion residues), microparticles of natural calcium carbonates (chalk) or synthetic calcium carbonates, synthetic silicates or natural silicates (such as kaolin, talc, mica, cloisite), silicas (in the absence of coupling agent), titanium oxides, aluminas, aluminosilicates (clay, bentonite), and mixtures thereof. Colouring fillers or fillers coloured, for example, by pigments could advantageously be used to colour the composition according to the colour desired. Preferentially, the composition of the invention comprises a filler other than a reinforcing filler selected from the group consisting of chalk, talc, kaolin and mixtures thereof.

The physical state in which the filler is provided is not important, whether it is in the form of a powder, micropearls, granules, beads or any other appropriate densified form. Of course, filler is also understood to mean mixtures of various reinforcing and/or nonreinforcing fillers.

These reinforcing or other fillers are customarily there to give dimensional stability, i.e. a minimum mechanical strength, to the final composition. Proportionally less thereof is preferably placed in the composition when the filler is known to be reinforcing with respect to an elastomer, in particular a diene elastomer such as natural rubber or polybutadiene.

A person skilled in the art will know, in the light of the present description, how to adjust the filler content of the composition of the invention in order to achieve the desired levels of properties and to adapt the formulation to the specific application envisaged. Preferentially, the composition of the invention comprises from 0 to less than 100 phr of filler, preferably from 0 to less than 70 phr filler, including 0 to less than 15 phr of reinforcing filler, preferably 0 to less than 10 phr of reinforcing filler.

More preferentially still, the composition of the invention comprises from 0 to 70 phr of filler, including 0 to less than 5 phr of reinforcing filler. Very preferentially, the composition of the invention comprises a filler other than a reinforcing filler, having a content that may range from 5 to 70 phr, preferably from 10 to 30 phr.

Depending on the envisaged application, the invention may in particular come in two embodiments, depending on the filler content. This is because an excessively high amount of filler is detrimental to the required properties of flexibility, deformability and flowability, while the presence of a certain amount of filler (for example from 30 to less than 120 phr), makes it possible to improve the processability and reduce the cost.

Thus, according to a first specific embodiment, the composition has a very low content of filler, i.e. it comprises from 0 to less than 30 phr of filler in total (including 0 to less than 30 phr of reinforcing filler), preferably 0 to less than 30 phr of filler, including 0 to less than 15 phr of reinforcing filler (more preferably 0 to less than 10 phr of reinforcing filler). According to this first embodiment, this composition has the advantage of making possible a self-sealing composition having good puncture-resistant properties at low temperature and at high temperature.

More preferably, according to this first specific embodiment, if a reinforcing filler is present in the composition of the invention, its content is preferably less than 5 phr (i.e. between 0 and 5 phr), in particular less than 2 phr (i.e. between 0 and 2 phr). Such contents have proved to be particularly favourable to the process for manufacturing the composition of the invention, while giving the latter an excellent self-sealing performance. Use is more preferably made of a content of between 0.5 and 2 phr, in particular when carbon black is concerned.

Preferably again according to this first specific embodiment, if a filler other than a reinforcing filler is used, its content is preferably from 5 to less than 30 phr, in particular from 10 to less than 30 phr.

Furthermore, according to a second specific embodiment, which is preferred, the composition comprises from 30 to less than 120 phr of filler, preferably from more than 30 to less than 100 phr and more preferably from 35 to 80 phr, including, according to this second embodiment, from 0 to less than 30 phr of reinforcing filler (more preferably from 0 to less than 15 phr). According to this second specific embodiment, this composition has the advantage of improving the processability and of reducing the cost while not being adversely affected too much with regard to its properties of flexibility, deformability and flowability. Furthermore, this second embodiment confers, on the composition, a markedly improved puncture-resistance performance.

Preferably, according to this second specific embodiment, if a reinforcing filler is present in the composition of the invention, its content is preferably less than 5 phr (i.e. between 0 and 5 phr), in particular less than 2 phr (i.e. between 0 and 2 phr). Such contents have proved to be particularly favourable to the process for manufacturing the composition of the invention, while giving the latter an excellent self-sealing performance. Use is more preferably made of a content of between 0.5 and 2 phr, in particular when carbon black is concerned.

Preferably, according to this second specific embodiment, the content of filler other than reinforcing filler is from 5 to less than 120 phr, in particular from 10 to less than 100 phr and more preferably from 15 to 80 phr. Very preferably, the content of filler other than reinforcing filler is within a range extending from 25 to 50 phr, more preferably still 30 to 50 phr.
Liquid plasticizer

The composition of the layer of self-sealing product according to the second embodiment can additionally comprise, at a content of less than 60 phr (in other words, between 0 and 60 phr), a plasticizing agent which is liquid (at 23° C.), referred to as a “low Tg” plasticizing agent, the role of which is in particular to soften the matrix by diluting the diene elastomer and the hydrocarbon resin, improving in particular the “low-temperature” self-sealing performance (i.e. typically for a temperature below 0° C.); its Tg is by definition below −20° C. and is preferably below −40° C.

Any liquid elastomer or any extender oil, whether of aromatic or nonaromatic nature, more generally any liquid plasticizing agent known for its plasticizing properties with respect to elastomers, in particular diene elastomers, can be used. At ambient temperature (23° C.), these plasticizers or these oils, which are more or less viscous, are liquids (that is to say, as a reminder, substances which have the ability to eventually assume the shape of their container), in contrast in particular to hydrocarbon resins, which are by nature solid at ambient temperature.

Suitable in particular are liquid elastomers having a low number-average molecular weight (Mn), typically of between 300 and 90 000, more generally between 400 and 50 000, for example in the form of liquid BR, liquid SBR, liquid IR or liquid depolymerized natural rubber, such as described, for example, in the abovementioned patent documents U.S. Pat. No. 4,913,209, U.S. Pat. No. 5,085,942 and U.S. Pat. No. 5,295,525. Use may also be made of mixtures of such liquid elastomers with oils, such as described below.

Extender oils, in particular those selected from the group consisting of polyolefin oils (that is to say, resulting from the polymerization of olefins, monoolefins or diolefins), paraffinic oils, naphthenic oils (of low or high viscosity and hydrogenated or nonhydrogenated), aromatic or DAE (Distillate Aromatic Extracts) oils, MES (Medium Extracted Solvates) oils, TDAE (Treated Distillate Aromatic Extracts) oils, mineral oils, vegetable oils (and their oligomers, e.g. rapeseed, soybean or sunflower oils) and the mixtures of these oils, are also suitable.

According to a specific embodiment, use is made, for example, of an oil of the polybutene type, in particular a polyisobutylene (abbreviated to “PIB”) oil, which has demonstrated an excellent compromise in properties in comparison with the other oils tested, in particular with a conventional oil of the paraffinic type. By way of examples, PIB oils are sold in particular by Univar under the name “Dynapak Poly” (e.g. “Dynapak Poly 190”) and by BASF under the names “Glissopal” (e.g. “Glissopal 1000”) or “Oppanol” (e.g. “Oppanol B12”); paraffinic oils are sold, for example, by Exxon under the name “Telura 618” or by Repsol under the name “Extensol 51”.

Also suitable as liquid plasticizers are ether, ester, phosphate or sulphonate plasticizers, more particularly those selected from esters and phosphates. Mention may be made, as preferred phosphate plasticizers, of those which comprise between 12 and 30 carbon atoms, for example trioctyl phosphate. Mention may in particular be made, as preferred ester plasticizers, of the compounds selected from the group consisting of trimellitates, pyromellitates, phthalates, 1,2 cyclohexanedicarboxylates, adipates, azelates, sebacates, glycerol triesters and the mixtures of these compounds. Mention may be made, among the above triesters, as preferred glycerol triesters, of those which are composed predominantly (for more than 50% by weight, more preferably for more than 80% by weight) of an unsaturated Cis fatty acid, that is to say a fatty acid selected from the group consisting of oleic acid, linoleic acid, linolenic acid and the mixtures of these acids. More preferably, whether it is of synthetic origin or natural origin (case, for example, of sunflower or rapeseed vegetable oils), the fatty acid used is composed for more than 50% by weight, more preferably still for more than 80% by weight, of oleic acid. Such triesters (trioleates) having a high content of oleic acid are well known; they have been described, for example, in application WO 02/088238 (or US 2004/0127617) as plasticizing agents in tire treads.

The number-average molecular weight (Mn) of the liquid plasticizer is preferably between 400 and 25 000 g/mol, more preferably still between 800 and 10 000 g/mol. For excessively low Mn weights, there exists a risk of the plasticizer migrating outside the composition, whereas excessively high weights can result in excessive stiffening of this composition. An Mn weight of between 1 000 and 4 000 g/mol has proved to constitute an excellent compromise for the targeted applications, in particular for use in a tire.

The number-average molecular weight (Mn) of the plasticizer may be determined in a known way, in particular by SEC, the sample being dissolved beforehand in tetrahydrofuran at a concentration of approximately 1 g/l; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analysis time is 30 min. A set of two Waters columns with the Styragel HT6E name is used. The injected volume of the solution of the polymer sample is 100 μl. The detector is a Waters 2410 differential refractometer and its associated software, for evaluating the chromatographic data, is the Waters Millennium system. The calculated average molecular weights are relative to a calibration curve produced with polystirene standards.

To sum up, the liquid plasticizer is preferably selected from the group consisting of liquid elastomers, polyolefin oils, naphthenic oils, paraffinic oils, DAE oils, MES oils, TDAE oils, mineral oils, vegetable oils, ether plasticizers, ester plasticizers, phosphate plasticizers, sulphonate plasticizers and the mixtures of these compounds. More preferably, this liquid plasticizer is selected from the group consisting of liquid elastomers, polyolefin oils, vegetable oils and the mixtures of these compounds.

A person skilled in the art will know, in the light of the description and implementational examples which follow, how to adjust the amount of liquid plasticizer as a function of the specific conditions of use of the self-sealing composition, in particular of the tire in which it is intended to be used.

Preferably, the content of liquid plasticizer is within a range from 5 to 40 phr, more preferably within a range from 10 to 30 phr. Below the minima indicated, there is a risk of the elastomer composition exhibiting a stiffness which is too high for some applications, whereas, above the recommended maxima, a risk arises of insufficient cohesion of the composition and of a deterioration in the self-sealing properties.
Various additives

The base constituents of the self-sealing layer described above, namely unsaturated diene elastomer, plasticizing hydrocarbon resin, optional liquid plasticizer and optional filler, are sufficient alone for the self-sealing composition to fully perform its puncture-resistance role with regard to the tires in which it is used.

However, various other additives can be added, typically in a small amount (preferably at contents of less than 20 phr, more preferably of less than 15 phr), such as, for example, protective agents, such as UV stabilizers, antioxidants or antiozonants, various other stabilizers, or colouring agents which can advantageously be used for the colouring of the self-sealing composition. Depending on the targeted application, fibres, in the form of short fibres or of slurry, might optionally be added to give greater cohesion to the self-sealing composition.

According to a preferred embodiment of the second embodiment of the composition of the layer of self-sealing product, the self-sealing composition additionally comprises a system for crosslinking the unsaturated diene elastomer which can be composed of just one or several compounds. This crosslinking agent is preferably a crosslinking agent based on sulphur and/or on a sulphur donor. In other words, this crosslinking agent is a “vulcanization” agent.

According to a preferred embodiment, the vulcanization agent comprises sulphur and, as vulcanization activator, a guanidine derivative, that is to say a substituted guanidine. Substituted guanidines are well known to a person skilled in the art (see, for example, WO 00/05300): mention will be made, as nonlimiting examples, of N,N′-diphenylguanidine (abbreviated to “DPG”), triphenylguanidine or else di(o-tolyl)guanidine. Use is preferably made of DPG. The sulphur content is, for example, between 0.1 and 1.5 phr, especially between 0.2 and 1.2 phr (in particular between 0.2 and 1.0 phr), and the content of guanidine derivative is itself between 0 and 1.5 phr, in particular between 0 and 1.0 phr (in particular within a range from 0.2 to 0.5 phr).

Said crosslinking or vulcanization agent does not require the presence of a vulcanization accelerator. According to a preferred embodiment, the composition can thus be devoid of such an accelerator or at the very most can comprise less than 1 phr thereof, more preferably less than 0.5 phr thereof.

However, in general, if such an accelerator is used, mention may be made, as an example, of any compound (“primary” or “secondary” accelerator) capable of acting as vulcanization accelerator for diene elastomers in the presence of sulphur, in particular accelerators of the thiazole type and also their derivatives, and accelerators of sulphenamide, thiuram, dithiocarbamate, dithiophosphate, thiourea and xanthate types. Mention may in particular be made, as examples of such accelerators, of the following compounds: 2-mercaptobenzothiazyl disulphide (abbreviated to “MBTS”), N-cyclohexyl-2-benzothiazolesulphenamide (“CBS”), N,N-dicyclohexyl-2-benzothiazolesulphenamide (“DCBS”), N-(tert-butyl)-2-benzothiazolesulphenamide (“TBBS”), N-(tert-butyl)-2-benzothiazolesulphenimide (“TB SI”), zinc dibenzyldithiocarbamate (“ZBEC”), 1-phenyl-2,4-dithiobiuret (“DTB”), zinc dibutyl phosphorodithioate (“ZBPD”), zinc 2-ethylhexyl phosphorodithioate (“ZDT/S”), bis[O,O-di(2-ethylhexyl)thiophosphonyl] disulphide (“DAPD”), dibutylthiourea (“DBTU”), zinc isopropyl xanthate (“ZIX”) and the mixtures of these compounds. According to another advantageous embodiment, the above vulcanization system can be devoid of zinc or of zinc oxide (known as vulcanization activators) or at the very most can comprise less than 1 phr thereof, more preferably less than 0.5 phr thereof.

According to another preferred specific embodiment of the invention, the vulcanization agent comprises a sulphur donor. The amount of such a sulphur donor will be adjusted preferably to between 0.5 and 15 phr, more preferably between 0.5 and 10 phr (in particular between 1 and 5 phr), in particular so as to achieve the preferred equivalent sulphur contents indicated above.

Sulphur donors are well known to a person skilled in the art; mention will in particular be made of thiuram polysulphides, which are known vulcanization accelerators and which have the formula (I):

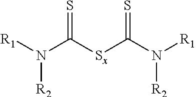

in which:
x is a number (an integer, or a decimal number in the case of mixtures of polysulphides) which is equal to or greater than two, preferably within a range from 2 to 8;
R₁ and R₂, which are identical or different, represent a hydrocarbon radical preferably chosen from alkyls having from 1 to 6 carbon atoms, cycloalkyls having from 5 to 7 carbon atoms, or aryls, aralkyls or alkaryls having from 6 to 10 carbon atoms.

In the above formula (I), R₁ and R₂ might form a divalent hydrocarbon radical comprising from 4 to 7 carbon atoms.

These thiuram polysulphides are more preferably selected from the group consisting of tetrabenzylthiuram disulphide (“TBzTD”), tetramethylthiuram disulphide (“TMTD”), dipentamethylenethiuram tetrasulphide (“DPTT”), and the mixtures of such compounds. Use is more preferably made of TBzTD, particularly at the preferred contents indicated above for a sulphur donor (i.e., between 0.1 and 15 phr, more preferably between 0.5 and 10 phr, in particular between 1 and 5 phr).

In addition to the solid elastomers and other additives described above, the composition of the invention might also comprise, preferably according to a minor fraction by weight with respect to the blend of solid elastomers A and B, solid polymers other than elastomers, such as, for example, thermoplastic polymers.

In addition to the elastomers described above, the self-sealing composition might also comprise, still according to a minor fraction by weight with respect to the unsaturated diene elastomer, polymers other than elastomers, such as, for example, thermoplastic polymers compatible with the unsaturated diene elastomer.

Manufacture of the Layer of Self-Sealing Product

The composition of the self-sealing layer according to the second embodiment described above can be manufactured by any appropriate means, for example by mixing and/or kneading in paddle mixers or open mills, until an intimate and homogeneous mixture of its various components has been obtained

The adapter may comprise at least one, optionally removable, conductive strip positioned over all or part of the circumferential perimeter of said adapter and along a complete path extending from the adapter seat to the rim J.

Preferably, the conductive strip is positioned entirely at the radially outer surface of the body or is partially buried under the radially outer surface of the body.

Preferably, the conductive strip has an electrical resistivity less than or equal to 10⁸ ohm·cm, and preferably less than or equal to 10⁷ ohm·cm.

Preferably, the conductive strip is made up, as desired, of a metallic leaf or of an elastomer composition comprising carbon black in an amount greater than or equal to 15% and preferably greater than or equal to 20%, it being possible for the carbon black in the elastomer composition to have a specific surface area greater than or equal to 500 m²/g.

Preferably, the conductive strip is bonded or crosslinked to the elastomer composition of the body.

The invention will now be described with the aid of the examples and the single FIGURE which follow and which are given purely by way of illustration. This single FIGURE shows a schematic view, in radial section, of a mounted assembly according to the invention.

As the single FIGURE shows, they amounted assembly of general reference 1 comprises a tire P, mounted on two adapters A, themselves mounted on a rim J.

The mounted assembly according to the invention can be used with any type of tire, be they radial- or cross-ply tires, or even with tires of the type having self-supporting sidewalls.

The mounting of this assembly according to the invention takes place in a conventional manner. The adapters are firstly positioned on the rim, then the tire is positioned on the adapters.

The tire of which the design per se is unaltered in the invention, consists of a tread reinforced by a crown reinforcement joined to two beads B on either side of an equatorial plane XX′ passing through the centre of the tire, by way of two sidewalls 1. A carcass reinforcement 2 that mainly reinforces the sidewalls 1 is anchored in each bead B to at least one bead wire, in this case of the “braided” type 3, so as to form turn-ups 4.

The radially inner wall 2a of the carcass ply 2 is covered with a layer of elastomer composition (not represented), the role of which is to render the tire airtight to the gas. Said layer of elastomer composition is preferably covered with a layer of a self-sealing composition 2b. This layer 2b consists of a thermoplastic stirene elastomer and 400 phr of an extender oil for extending said polymer, such as polyisobutylene with an average molecular weight of around 1000.

The rim J comprises a groove 6, known as a mounting groove, that connects, on either side of the equatorial plane, two rim seats 7 that are axially extended by rim flanges 8, the radially outer edges of which are curved.

The adapter A mainly comprises an axially outer end 9, an axially inner end 10 and a body 11 connecting the said end 9 to the said end 10.

The axially outer end 9 comprises an outer reinforcing element 20. During the mounting of the tire, the bead seat for the bead B is fitted into the space created by this outer reinforcing element 20.

The adapter A, which is positioned at each bead B of the tire, may be symmetrical or non-symmetrical. Symmetry means that the overall length of the body 11 is identical on the two adapters. When the assembly (tire, rim and adapter) is mounted, the beads B of the tire are positioned on the adapter seat 18 and made to bear axially against a bearing face 21.

The adapter comprises, on one side, an axially outer end 9 with an outer reinforcer 20 having a substantially spherical geometric shape in section, consisting of a composite material such as glass-reinforced resin, and, on the other side, an axially inner end 10 with a metal reinforcer 16, and finally a body 11 made up of two plies (not represented) that comprise textile cords. The cords of each ply are mutually parallel. On the one hand, said plies are attached axially on the inside and radially on the outside to the walls of the reinforcer 20, and on the other hand, they are anchored, in the end 10, to the metal reinforcer 16, such as a bead wire forming a turn-up at each end.

The body 11 comprises a substantially cylindrical adapter seat 18 that is intended to receive a bead of the tire that is disposed at the axially outer end of the body 11.

The body 11 also comprises an adapter bearing face 21 that is contained substantially in a plane perpendicular to the rotation axis, is situated on the axially inner face of the axially outer end, and is intended to keep the bead in place in its housing.

The adapter comprises, in this single FIGURE, an annular seat reinforcer 19, which is not attached to the outer reinforcer 20. These two reinforcers 19, 20 are entirely independent of one another.

The reinforcer 19 is made up of a tri-layer comprising metal reinforcers in the form of wires, alternating with an elastomer of the rubber-resin type. The reinforcer 19 has a radial thickness of about 1.5 mm and an axial length of about 15 mm.

The elastomer layer of the reinforcer 19 has a radial thickness of about 0.3 mm and an axial length of about 15 mm A layer of elastomer covers all of the elements that make up the adapter, namely the reinforcer 20, the reinforcer 16, the body 11 and the radially outer surface of the reinforcer 20.

The following examples show the results obtained with the assembly according to the invention.

### EXAMPLE: KERB KNOCK TESTS

This test consists in causing a mounted assembly to mount a kerb at an angle of attack of 30°. The choice of this angle is based on the fact that it constitutes a very harmful stress for a tire. The test is carried out with two different kerb heights (90 mm and 110 mm).

The test proceeds as follows. Several passes of the wheel at different speeds are carried out until the tire is punctured. The starting speed is 20 km/h and then the speed is incremented by 5 km/h on each new pass.

A conventional assembly without an adapter (control 1) is compared with an assembly provided with an adapter according to the document WO00/78565 (control 2) and with an assembly provided with an adapter according to the invention (invention). These assemblies are all of the size 205/55R16 comprising a 6.5 J16 rim. The results are collated in the following Table I and are given in percent:

TABLE I

| | Control 1 | Control 2 | Invention |
|---|---|---|---|
| Percentage of the | 100 | >150 | >150 |
| puncturing speed | | | |
| compared with | | | |
| control - kerb | | | |
| height 90 mm | | | |
| Level of vertical | 100 | 50 | 40 |
| thrust force (Fz) | | | |
| recorded at the | | | |
| puncturing speed | | | |
| State of the | Tire punctured | Tire and wheel | Tire, adapter and |
| mounted assembly | Wheel marked | intact | wheel intact |
| following the | | Adapter | |
| knocks | | plastically | |
| | | deformed | |

Results greater than 100 show an improvement in behaviour when subjected to a lateral knock.
The test carried out at the kerb height of 90 mm led to the puncturing of the control tire at a speed of 30 km/h, whereas the assembly according to the invention did not suffer any damage at the same speed, or even at a speed of 50 km/h.
The test carried out at the kerb height of 110 mm led to the puncturing of the control tire at a speed of 20 km/h, whereas the assembly according to the invention did not suffer any damage at the same speed, or even at a speed of 50 km/h.

1. Rolling mounted assembly having a rotation axis and comprising:
a tire having two beads and an inner wall;
at least one adapter;
a rim;
said adapter providing the connection between one of the beads and the rim,
said rim having two rim seats and two rim flanges;
said adapter having:
an axially inner end that is intended to be mounted on the rim seat and comprises an inner reinforcing element,
an axially outer end that comprises an outer reinforcing element,
a body that connects said outer end to said inner end so as to form a single piece and comprises at least one main reinforcement that provides the connection between said outer reinforcer and said inner reinforcer,
a substantially cylindrical adapter seat intended to receive one of said beads, said seat being situated at the axially outer end of said body,
an adapter bearing face substantially contained in a plane perpendicular to the rotation axis, said bearing face being situated on the axially inner face of the axially outer end,
wherein the inner wall of the tire is partially or completely covered by at least one layer of a self-sealing composition.

2. The assembly according to claim 1, wherein the self-sealing composition has a Shore 00 hardness of less than or equal to 10.

3. The assembly according to claim 1, wherein the self-sealing composition is selected from a composition based on a thermoplastic stirene (TPS) elastomer, or from a composition comprising at least one unsaturated diene elastomer, or from terpene polybutene resins and as main component, or from silicone-based, urethane-based, stirene-based or else ethylene-based compounds, or from a composition based on a butyl elastomer.

4. The assembly according to claim 3, wherein the composition based on a thermoplastic stirene (TPS) elastomer comprises more than 200 phr of an extender oil for extending said elastomer.

5. The assembly according to claim 3, wherein the composition comprising at least one unsaturated diene elastomer comprises between 30 and 90 phr of a hydrocarbon resin, a liquid plasticizer, the glass transition temperature (Tg) of which is below −20° C., at a weight content of between 0 and 60 phr and from 0 to 120 phr of a filler.

6. The assembly according to claim 3, wherein the composition based on a butyl elastomer comprises a non-halogenated butyl elastomer.

7. The assembly according to claim 3, wherein the composition based on a butyl elastomer comprises between 5 and 40 phr of an extender oil selected from polyisobutylene, between 5 and 55 phr of a tackifying resin, and a non-reinforcing filler.

8. The assembly according to claim 7, wherein the polyisobutylene has a molecular weight of less than or equal to 10 000.

9. The assembly according to claim 7, wherein the non-reinforcing filler is selected from chalk or kaolin.

10. The assembly according to claim 1, wherein the reinforcing element of the axially outer end is positioned radially on the outside of the adapter seat.

11. The assembly according to claim 3, wherein the TPS is the predominant elastomer of the self-sealing layer.

12. The assembly according to claim 3, wherein the TPS elastomer is selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS), stirene/ethylene/ethylene/propylene/stirene (SEEPS) block copolymers and mixtures of these copolymers.

13. The assembly according to claim 3, wherein the TPS elastomer is selected from the group consisting of SEBS copolymers, SEPS copolymers and mixtures of these copolymers.

14. The assembly according to claim 3, wherein the unsaturated diene elastomer is selected from the group consisting of polybutadienes, natural rubber, synthetic polyisoprenes, butadiene copolymers, isoprene copolymers and mixtures of such elastomers.

15. The assembly according to claim 3, wherein the unsaturated diene elastomer is an isoprene elastomer, preferably selected from the group consisting of natural rubber, synthetic polyisoprenes and mixtures of such elastomers the unsaturated diene elastomer is an isoprene elastomer, preferably selected from the group consisting of natural rubber, synthetic polyisoprenes and mixtures of such elastomers.

16. The assembly according to claim 3, wherein the unsaturated diene elastomer is a blend of at least two solid elastomers, a polybutadiene or butadiene copolymer elastomer, referred to as “elastomer A”, and a natural rubber or synthetic polyisoprene elastomer, referred to as “elastomer B”, the elastomer A:elastomer B weight ratio being within a range from 10:90 to 90:10.

17. The assembly according to claim 16, wherein the elastomer A:elastomer B weight ratio is within a range from 20:80 to 80:20.

18. The assembly according to claim 7, wherein the polyisobutylene has a molecular weight of less than or equal to 5000.

19. The assembly according to claim 16, wherein the elastomer A:elastomer B weight ratio is within a range from 30:70 to 70:30.
